(19) United States
(12) Patent Application Publication
(10) Pub. No.: US 2017/0046452 A1
(43) Pub. Date: Feb. 16, 2017

(54) DEVICE FOR DIGITAL MODELING OF ACTUAL SURFACES

(71) Applicant: VERTICA Lukasz Rutkiewicz, Bydgoszcz (PL)

(72) Inventor: Lukasz Rutkiewicz, Bydgoszcz (PL)

(73) Assignee: VERTICA Lukasz Rutkiewicz, Bydgoszcz (PL)

(21) Appl. No.: 14/827,043

(22) Filed: Aug. 14, 2015

(51) Int. Cl. G06F 17/50

(52) U.S. Cl. CPC G06F 17/50

(57) ABSTRACT

In accordance with some implementations, the described device includes a molding modeling, or forming pin that includes an elongate casing with an inserted spindle that includes (successively and respectively, in some implementations): a first part comprising one or more hard magnetic materials, a second part comprising one or more nonmagnetic materials, and a third part comprising one or more hard magnetic materials. In some implementations, electric coils are slid or otherwise disposed on the first part of the spindle and on the third part of the spindle.

### BACKGROUND OF THE INVENTION

1. Field of the Invention

Some implementations of the invention relate to a device for digital modelling of one or more actual surfaces applicable in industry, especially in the processing of plastics, in the exercise of models, and in the development of prototypes. In accordance with some embodiments, the device can be also useful in the short-serial production or individual products made with one or more types of plastics, polymers, or rubber.

2. Background and Related Art

There are relatively few, or even no, known devices for digital modelling of the actual surfaces.

However, there is a range of solutions for the positioning of a single element disposed in the electromagnetic field. For example, the publication WO2013174483A2 disclosing the method of determining the position of the mobile unit having a first coil disposed in relation to the stationary second coil and a system for carrying out the method where the first coil has two partial windings, the second coil has also two partial windings, with determined intensity of inductive coupling of the partial windings of the first coil or of the first coil with the partial windings of the second coil or the second coil, where the phase delay of the alternating voltage induced signals is marked, with the range of positions determined based on the intensity of the coupling, where the phase delay is the unambiguous function of the position and the position is determined based on the phase delay.

The use of alternating current is at least one disadvantage of the solution, making it relatively hard, if not impossible, to use it in electronic circuits of constant voltage.

### SUMMARY OF THE INVENTION

In accordance with some implementations, the described device includes a molding pin that includes an elongate casing with an inserted spindle that includes (successively and respectively, in some implementations): a first part comprising one or more hard magnetic materials, a second part comprising one or more nonmagnetic materials, and a third part comprising one or more hard magnetic materials. In some implementations, electric coils are slid or otherwise disposed on the first part of the spindle and on the third part of the spindle.

### BRIEF DESCRIPTION OF THE DRAWING

In order that the manner in which the above recited and other features and advantages of the present invention are obtained, a more particular description of the invention will be rendered by reference to specific embodiments thereof, some of which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative embodiment of a device for digital modeling;

FIG. 2 illustrates a block diagram of a system using the device in accordance with some embodiments; and

FIG. 3 illustrates a signal processing algorithm in accordance with some embodiments of the described systems and methods.

### DETAILED DESCRIPTION OF THE INVENTION

In accordance with some embodiments, the described systems and methods include a series of molding pins (or modeling pins or forming pins) disposed in parallel, side by side in the X axis and the Y axis, with the ends of these pins are located at substantially the same height constituting a plane. In some embodiments, each molding pin has a spindle, comprising three parts: a first part comprising one or more hard magnetic materials, a second part comprising one or more nonmagnetic materials, and a third part comprising one or more hard magnetic materials. Additionally, in some embodiments, the molding pin comprises an electric coil on the first part of the spindle and another electric coil on the third part of the spindle to form, respectively, a first positioning section and a second positioning section, wherein the coils are configured to generate magnetic fields with opposite-direction currents. In some embodiments, the molding pins are connected in blocks and the described system controls their location with each of the pin in the Z-axis through multiplexers and the system is connected to a microcontroller (e.g., any suitable processor, microprocessor, computer, etc.) which is connected to an interface (e.g., any suitable user interface, computer system, touchscreen, keyboard, input device, output device, computer software, a drawing program, and/or other suitable interface). In some embodiments, the ends of the molding pins are disposed adjacent to each other.

While the described device can operate in any suitable manner, in some embodiments, it operates as follows: In some embodiments, the current flow through the coils creates magnetic fields with opposite polarities. In some embodiments, the coil of the first section is configured to push the spindle out of the casing while the second coil section is configured to retract the spindle into the casing. By controlling the current values of the respective molding pins, that is realized by the described system based on the signals from the microcontroller, which (in some embodiments) receives properly processed data via the interface, for example from a computer program, such as CAD, precise spindle alignment of the molding pin follows. In some embodiments, molding pins are connected in blocks and a primary one will be joined in groups forming larger molding areas.

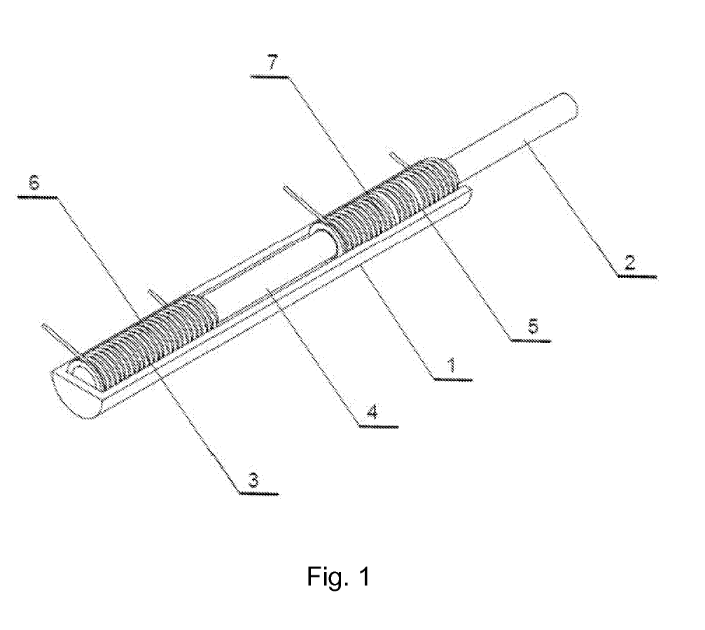

non-limiting illustration of a representative embodiment of the described invention is shown in the drawings, in which FIG. 1 represents a single molding pin, which comprises an elongate casing 1 with the inserted spindle 2 comprising successively connected the first part 3 comprising a hard magnetic material, the second part 4 comprising a nonmagnetic material, and the third part comprising a hard magnetic material. Moreover, FIG. 1 shows that, in some embodiments, on the first part of the spindle 3 and on the third part 5 of the spindle 2, the electric coils are slid 6, 7.

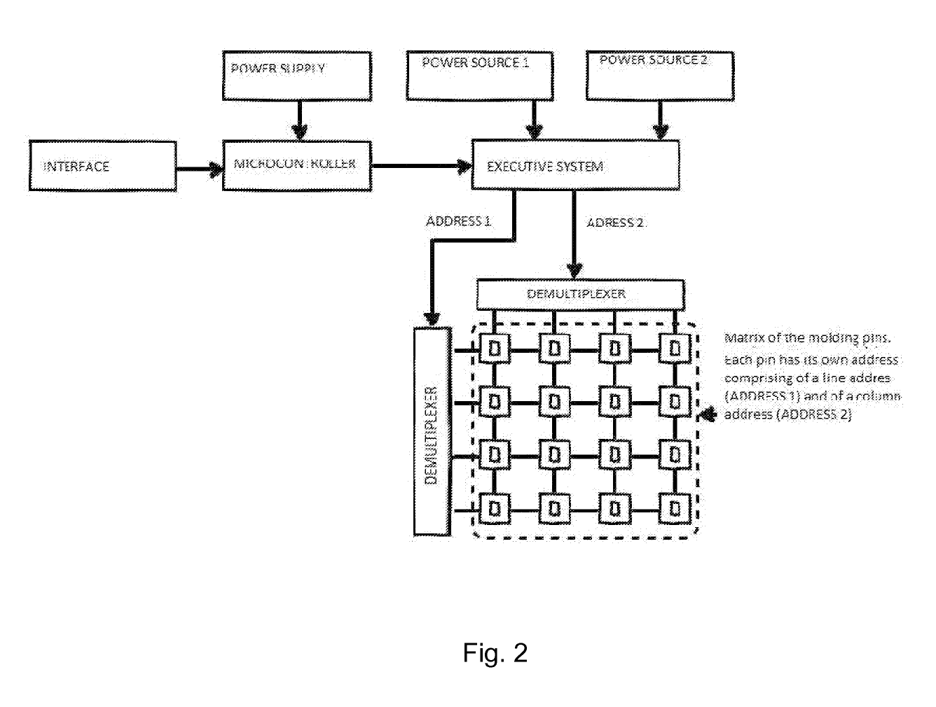

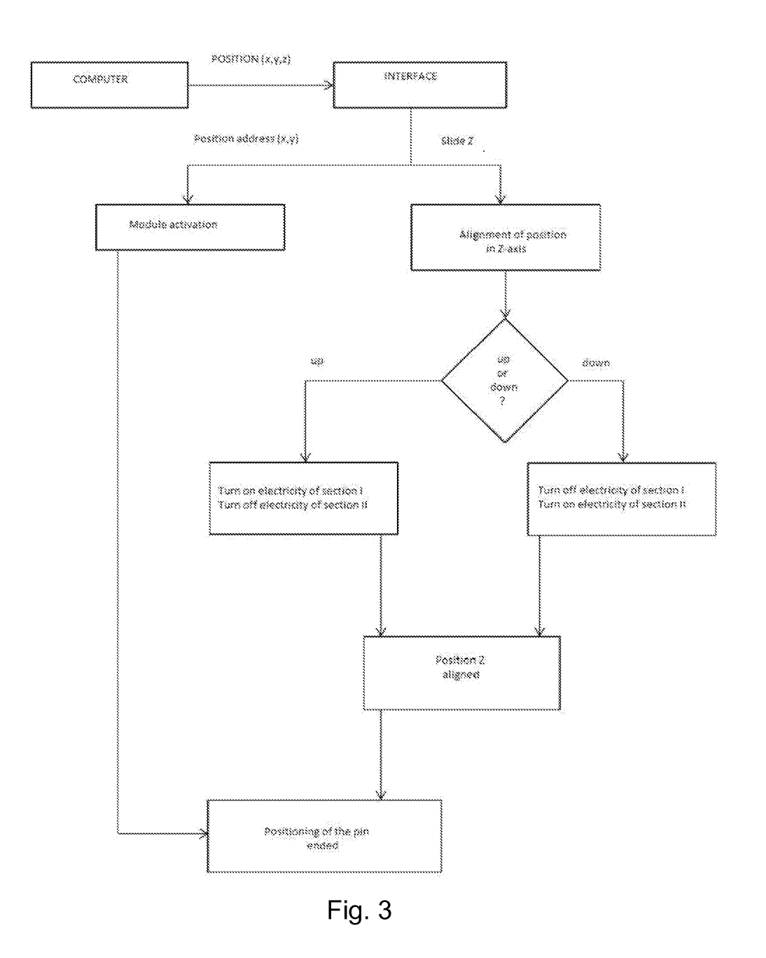

In accordance with some embodiments, FIG. 2 shows a block diagram of a suitable system for use with some embodiments of the described invention. While the system can comprise any suitable component, FIG. 2 shows that, in some embodiments, the system includes an interface (or a system, input device, output device, piece of software, drawing program, computer, and/or other block responsible for receiving information from the outside, for example from a computer that is connected to the device according to the invention). In accordance with some embodiments, the interface is configured to adjust the signal from the outside to the standards to be adopted by the microcontroller (e.g., a processor, microprocessor, computer, and/or other suitable device configured to accept external input signals indicating the address (and/or location) of the molding pin and the height of the spindle protrusion and to converts it into the signals for the executive system (or a processor, computer, and/or other suitable device that is configured to processes the received information from the microcontroller about the address of the molding pin contained in the matrix supported by the system and about the flow of current in the two coils, determining the sliding of the molding pin to a specific height in accordance with the signal sent from the outside. FIG. 3 shows schematically some embodiments of the signal processing algorithm as described above.

What is claimed is:

1. A device for digital modelling of an actual surface, the device comprising:
multiple forming pins disposed in parallel, with an end of each of the pins being located at a substantially similar height, wherein each of the forming pins comprises a spindle that includes:
a first portion comprising a first hard magnetic material;
a second portion comprising a nonmagnetic material;
a third portion comprising a second hard magnetic material;
a first coil disposed at the first portion of the spindle, forming a first positioning section; and
a second coil disposed at the third portion of the spindle, forming a second positioning section,
wherein the first and second coils are configured to generate magnetic fields with opposite-direction currents.

2. The device of claim 1, wherein the end of each of the forming pins is disposed side by side.

3. The device of claim 1, wherein each of the forming pins is disposed in a matrix.

4. The device of claim 1, wherein each of the forming pins is disposed in parallel, side by side in both an X-axis and a Y-axis.

5. The device of claim 4, wherein each of the forming pins are connected to an executive system that is configured to control a location of each of the forming pins in a Z-axis through a multiplexer.

6. The device of claim 5, wherein the executive system is connected to a microcontroller which is connected to an interface.

7. The device of claim 1, wherein the spindle in each of the forming pins is disposed in an elongate casing.

8. The device of claim 7, wherein the first coil is configured to push the spindle out of the casing.

9. The device of claim 7, wherein the second coil is configured to retract the spindle into the casing.
